(19) United States
(12) Patent Application Publication
(10) Pub. No.: US 2012/0064412 A1
(43) Pub. Date: Mar. 15, 2012

(54) LITHIUM PRIMARY BATTERY

(76) Inventor: Shinichiro Tahara, Osaka (JP)

(21) Appl. No.: 13/322,040

(22) PCT Filed: Mar. 25, 2010
(86) PCT No.: PCT/JP2010/002109

§ 371 Date: Nov. 22, 2011

(30) Foreign Application Priority Data
Jul. 21, 2009 (JP) 2009 169874

(51) Int. Cl. H01M 4/583; H01M 4/38

(52) U.S. Cl. 429/231.7

(57) ABSTRACT

A lithium primary battery includes a positive electrode, a negative electrode, a separator and a nonaqueous electrolytic solution both disposed between the positive electrode and the negative electrode. The positive electrode contains carbon fluoride as a positive electrode active material, and the negative electrode contains metallic lithium as a negative electrode active material. The carbon fluoride includes a non-fluorinated carbon component. A spacing of a (001) plane of the carbon fluoride ranges from 7.0 Å to 7.5 Å, inclusive. A ratio of an X-ray diffraction peak intensity of the (001) plane of the carbon fluoride to an X-ray diffraction peak intensity of a (002) plane of the non-fluorinated carbon component ranges from 30 to 50, inclusive.

### RELATED APPLICATIONS

This application is the U.S. National Phase under 35 U.S.C. §371 of International Application No. PCT/JP2010/002109, filed on Mar. 25, 2010, which in turn claims the benefit of Japanese Application No. 2009-169874, filed on Jul. 21, 2009, the disclosures of which Applications are incorporated by reference herein.

### TECHNICAL FIELD

The present invention relates to a lithium primary battery using carbon fluoride as a positive electrode active material.

### BACKGROUND ART

Lithium primary batteries use a light metal such as lithium as a negative electrode active material, and manganese dioxide, carbon fluoride, or the like, as a positive electrode active material. Such lithium primary batteries have advantages that, for example, they have a high voltage and a large energy density, are less self-discharged, and have an extremely long storage life, which are not possessed by the other primary batteries. Therefore, lithium primary batteries are used for many electronic apparatuses.

Among them, a lithium primary battery using carbon fluoride as a positive electrode active material, and metallic lithium or an alloy thereof as a negative electrode active material is known to be a battery that is thermally and chemically stable and excellent in long-term storage characteristics. Carbon fluoride is prepared by allowing a carbon material to react with a fluorine gas at 200 to 700° C., and has a large capacity density of 864 mAh/g. Hereinafter, this type of lithium primary battery is referred to as a CF lithium primary battery.

Since the CF lithium primary battery has excellent long-term storage characteristics, that is, it can be stored for 10 years or more at room temperature, it is widely used for main power sources of various meters or memory backup power sources. However, the low-temperature discharge characteristics of the CF lithium primary battery are inferior to those of a lithium primary battery using manganese dioxide as a positive electrode active material.

Recently, applications requiring a wide operating temperature range from a high temperature range to a low temperature range in automobiles, industrial apparatuses, or the like, have been demanded. In order to apply the CF lithium primary battery for such applications, it is important to improve the low-temperature discharge characteristics.

In the CF lithium primary battery, discharge proceeds by an intercalation reaction of lithium ions into interlayer spaces of layered carbon fluoride. Therefore, in order to improve the low-temperature discharge characteristics, it is important to allow lithium ions to easily enter the interlayer spaces or to increase the diffusion speed of lithium ions in the interlayer spaces. In such circumstances, in order to improve the low-temperature discharge characteristics, a lithium primary battery using a low boiling-point solvent such as 1,2-dimethoxyethane for a nonaqueous electrolytic solution has been proposed for the purpose of increasing the diffusion speed of lithium ions in the interlayer spaces (for example, PTL 1).

However, when such a nonaqueous electrolytic solution is used, internal resistance of a battery is increased during storage in a high-temperature range of 60° C. or more. This is caused by the following phenomenon. The nonaqueous electrolytic solution, in particular, the low boiling-point solvent is decomposed on the surface of the positive electrode. Simultaneously, hydrofluoric acid is generated from the positive electrode. The hydrofluoric acid reacts with lithium of the negative electrode, thus forming lithium fluoride as a high-resistance film on the surface of the negative electrode.

### CITATION LIST

### Patent Literature

PTL 1: Japanese Patent Examined Publication No. S58-12991

### SUMMARY OF THE INVENTION

The present invention relates to a lithium primary battery that is excellent in both low-temperature discharge characteristics and high-temperature storage characteristics. The lithium primary battery of the present invention includes a positive electrode containing carbon fluoride as a positive electrode active material, a negative electrode containing metallic lithium as a negative electrode active material, a separator and a nonaqueous electrolytic solution disposed between the positive electrode and the negative electrode. Carbon fluoride includes a non-fluorinated carbon component. A spacing of a (001) plane of carbon fluoride ranges from 7.0 Å to 7.5 Å, inclusive. The ratio of an X-ray diffraction peak intensity of the (001) plane of carbon fluoride to an X-ray diffraction peak intensity of a (002) plane of the non-fluorinated carbon component ranges from 30 to 50, inclusive. The lithium primary battery of the present invention is characterized by using such carbon fluoride.

According to the present invention, the discharge characteristics at a low temperature are excellent, decomposition of the nonaqueous electrolytic solution, in particular, a low boiling-point solvent is inhibited even during high-temperature storage, and the increase in the internal resistance of the battery can be also inhibited.

### BRIEF DESCRIPTION OF DRAWINGS

FIG. 1 is a half sectional front view of a lithium primary battery in accordance with an exemplary embodiment of the present invention.

### DESCRIPTION OF EMBODIMENTS

Hereinafter, an exemplary embodiment of the present invention is described. Note here that the below-mentioned exemplary embodiment is one example embodying the present invention, and does not limit the technical scope of the present invention.

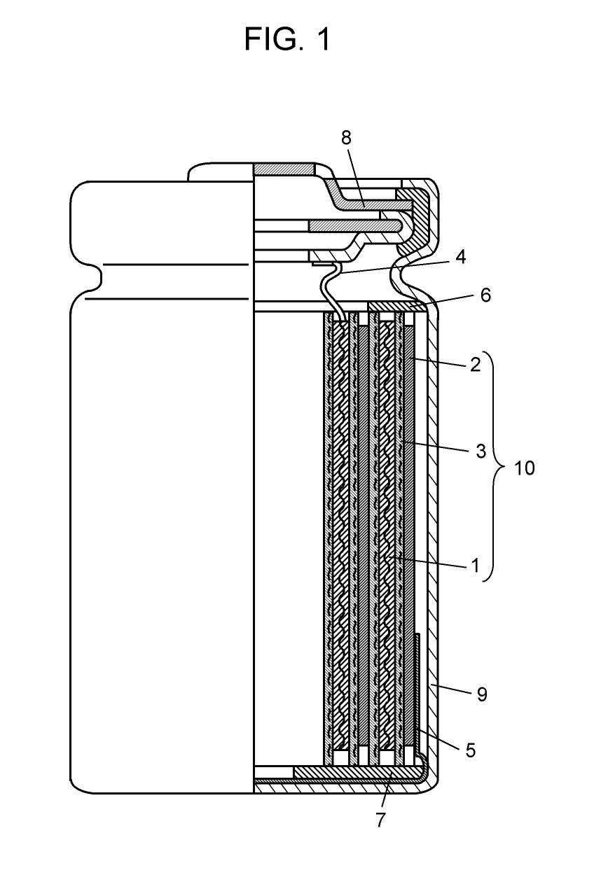

FIG. 1 is a schematic sectional view of a lithium primary battery in accordance with an exemplary embodiment of the present invention. The lithium primary battery includes positive electrode 1, negative electrode 2, and separator 3 and a nonaqueous electrolytic solution (not shown) which are disposed between positive electrode 1 and negative electrode 2. Positive electrode 1 contains carbon fluoride as an active material. Negative electrode 2 contains metallic lithium as an active material. Note here that FIG. 1 shows a cylindrical lithium primary battery. However, the present invention is not limited to this battery shape, and it can be applied to, for example, a coin type battery.

Positive electrode 1 is produced as follows. Carbon fluoride and an electrically conductive agent are mixed with each other, a binder and water are then added thereto, and the mixture is kneaded to prepare a positive electrode mixture. Examples of the electrically conductive agent include graphite powder such as artificial graphite powder and natural graphite powder, or a mixture of graphite powder and carbon black such as acetylene black. Any blending amount may be employed as long as the filling amount of carbon fluoride is large, a conductive path is formed, and the electrical resistance in the positive electrode is reduced. In particular, the blending amount of the electrically conductive agent is preferably 5 to 15 parts by weight with respect to 100 parts by weight of carbon fluoride.

Next, this positive electrode mixture is filled in a core material having a net shape or pores, for example, an expanded metal, a net and a punching metal, and the like, to produce a positive electrode intermediate. This positive electrode intermediate is roll-pressed, cut into a predetermined size, and a portion of the positive electrode mixture is peeled off and the positive electrode current collector is welded to the portion. In this way, a belt-like positive electrode 1 is produced.

Belt-like negative electrode 2 is produced by bonding lead 5 to metallic lithium or a lithium alloy such as Li—Al, Li—Sn, Li—NiSi and Li—Pb.

Positive electrode 1, negative electrode 2 and separator 3 disposed therebetween are wound in a spiral shape to form electrode group 10. Electrode group 10 is accommodated in case 9 together with a nonaqueous electrolytic solution (not shown). An organic solvent of the nonaqueous electrolytic solution is not particularly limited as long as it is an organic solvent usually used for the nonaqueous electrolytic solution of the lithium primary battery. More specifically, as the organic solvent, γ-butyrolactone, propylene carbonate, ethylene carbonate, 1,2-dimethoxyethane, and the like, can be used.

As a supporting electrolyte constituting the nonaqueous electrolytic solution, lithium borofluoride, lithium phosphorus hexafluoride, lithium trifluoromethanesulfonate, and compounds having an imide bond in the molecular structure such as lithium bis(trifluoromethane sulfone)imide (LiN(CF³SO₂)²), lithium bis(pentafluoroethane sulfone)imide (LiN(C₂F₅SO₂)₂), lithium (trifluoromethane sulfone) (nonafluorobutane sulfone)imide (LiN(CF₃SO₂)(C₄F₉SO₂)), can be used.

Sealing plate 8 is placed on an opening of case 9. Lead 4 connected to the core material of positive electrode 1 is connected to sealing plate 8. Lead 5 connected to negative electrode 2 is connected to case 9. Furthermore, top insulating plate 6 and bottom insulating plate 7 are disposed on the top and the bottom of electrode group 10, respectively, to prevent internal short-circuit.

Next, carbon fluoride as the positive electrode active material is described in detail. Carbon fluoride to be used in this exemplary embodiment includes a non-fluorinated carbon component. A spacing of a (001) plane of carbon fluoride (hereinafter, referred to as a CF (001) plane spacing) ranges from 7.0 Å to 7.5 Å, inclusive. The ratio of an X-ray diffraction peak intensity of the (001) plane of carbon fluoride (hereinafter, referred to as a CF (001) plane) to an X-ray diffraction peak intensity of a (002) plane of the non-fluorinated carbon component (hereinafter, referred to as a C (002) plane) ranges from 30 to 50, inclusive. By controlling the reaction progress when carbon is fluorinated in the range, the low-temperature discharge characteristics and high-temperature storage characteristics of a CF lithium primary battery can be improved.

The CF (001) plane spacing is measured by the X-ray diffraction method. When the CF (001) plane spacing is smaller than 7.0 Å, lithium ions are not easily inserted into interlayer spaces of carbon fluoride, so that the discharge characteristics at low a temperature are low. Furthermore, when the CF (001) plane spacing is larger than 7.5 Å, the nonaqueous electrolytic solution enters the interlayer spaces, thus causing decomposition of the nonaqueous electrolytic solution easily. Therefore, the high-temperature storage characteristics are lowered.

When the X-ray diffraction of carbon fluoride is carried out, a peak of the CF (001) plane appears around 2θ=12.5°. A peak of the C (002) plane appears around 2θ=25.8°. When a value of the ratio of intensities of the two peaks, CF (001)/C (002), is smaller than 30, much carbon, which is not fluorinated, is present on the surface of carbon fluoride, which causes decomposition of the nonaqueous electrolytic solution. Consequently, the high-temperature storage characteristics are lowered. Furthermore, when the value of the peak ratio of CF (001)/C (002) is larger than 50, since the amount of carbon, which is not fluorinated, in carbon fluoride is too small, the conductivity of the positive electrode mixture is lowered. Therefore, the discharge characteristics at a low temperature are low.

Next, a method for manufacturing carbon fluoride in accordance with this exemplary embodiment is described. Carbon fluoride is prepared by allowing a carbon material as a starting material to react with a fluorine gas at 200 to 700° C. The carbon material is not particularly limited, and petroleum coke, graphite, acetylene black, and the like, can be used.

When a temperature in fluorination becomes high, the rate of the fluorinated carbon becomes large, and the value of the peak ratio of CF (001)/C (002) becomes large. Furthermore, when the time of fluorination becomes longer, the CF (001) plane spacing tends to become larger. Therefore, when the carbon fluoride as the positive electrode active material to be used in this exemplary embodiment is prepared, the temperature and time in fluorination should be controlled appropriately. For example, petroleum coke having a (002) plane spacing of about 3.4 Å is used as a carbon raw material, the temperature in fluorination is preferably 400° C. or more and 420° C. or less, and the reaction time is preferably 30 hours or longer and 70 hours or less.

Hereinafter, the advantages of the present invention are described with reference to specific examples. While a nitrogen gas containing 18 vol. % of fluorine gas is allowed to flow toward petroleum coke having the (002) plane spacing of about 3.4 Å at a flow rate of 3 liter/min per kg of petroleum coke in a furnace of a nitrogen atmosphere, the temperature is allowed to gradually rise up to 410° C. This temperature is maintained for 50 hours to prepare carbon fluoride. The CF (001) plane spacing of the obtained carbon fluoride is 7.2 Å. Furthermore, the peak ratio of CF (001)/C (002) by the X-ray diffraction is 40. The measurement conditions of the X-ray diffraction are as follows.

Device: X'PertPRO manufactured by Spectris Co., Ltd.

Target/Monochrome: Cu/C

Voltage/Current: 40 kV/50 mA

Scanning mode: Continuous

Scanning range: 7 to 90°

Step width: 0.02°

Scanning speed: 50 s/step

Slit width (DS/SS/RS): 1/2°/None/0.1 mm

To 100 mass % of this carbon fluoride, 10 mass % graphite as the electrically conductive agent and 20 mass % polytetrafluoroethylene as the binder are mixed. To this mixture, pure water and surfactant are added and kneaded to prepare a wet-state positive electrode mixture. This wet-state positive electrode mixture is allowed to pass between two rotating rollers that rotate at equal velocity together with 0.1 mm-thick expanded metal made of stainless steel. Thus, the positive electrode mixture is filled in the expanded metal to produce a positive electrode intermediate. After drying, the positive electrode intermediate is roll-pressed by a roller press. The roll-pressed positive electrode intermediate is cut into a predetermined size (thickness: 0.30 mm, width: 24 mm, length: 180 mm), a part of the positive electrode mixture is peeled off to expose the core material, and lead 4 is connected to the exposed core material to produce positive electrode 1.

A metallic lithium plate is used for negative electrode 2. This metal plate is cut into a predetermined size (thickness: 0.20 mm, width: 22 mm, length: 185 mm), and lead 5 is bonded. The thus produced positive electrode 1 and negative electrode 2 are wound in a spiral shape with separator 3 made of polypropylene disposed therebetween to produce electrode group 10. Electrode group 10 is inserted into case 9, and then lead 4 is connected to sealing plate 8, and lead 5 is connected to case 9.

On the other hand, a nonaqueous electrolytic solution is preliminarily prepared by dissolving lithium borofluoride as electrolyte at a concentration of 1.0 mol/liter in a solvent mixture as a nonaqueous solvent composed of γ-butyrolactone and dimethoxyethane in a ratio of 6:4. This nonaqueous electrolytic solution is filled in case 9. Then, the opening of case 9 is sealed with sealing plate 8 to produce a cylindrical CF lithium primary battery having a diameter of 17 mm and height of 34.0 mm. This is referred to as battery A.

Next, carbon fluoride is prepared in the same manner as for battery A except that the fluorination temperature of petroleum coke is set to 420° C. and the reaction time is set to 70 hours. By using this carbon fluoride, battery B is produced in the same manner as for battery A. The CF (001) plane spacing of the obtained carbon fluoride is 7.5 Å. The peak ratio of CF (001)/C (002) by the X-ray diffraction is 50.

Next, carbon fluoride is prepared in the same manner as for battery A except that the fluorination temperature of petroleum coke is set to 400° C. and the reaction time is set to 70 hours. By using this carbon fluoride, battery C is produced in the same manner as for battery A. The CF (001) plane spacing of the obtained carbon fluoride is 7.5 Å. The peak ratio of CF (001)/C (002) by the X-ray diffraction is 30.

Next, carbon fluoride is prepared in the same manner as for battery A except that the fluorination temperature of petroleum coke is set to 420° C. and the reaction time is set to 30 hours. By using this carbon fluoride, battery D is produced in the same manner as for battery A. The CF (001) plane spacing of the obtained carbon fluoride is 7.0 Å. The peak ratio of CF (001)/C (002) by the X-ray diffraction is 50.

Next, carbon fluoride is prepared in the same manner as for battery A except that the fluorination temperature of petroleum coke is set to 400° C. and the reaction time is set to 30 hours. By using this carbon fluoride, battery E is produced in the same manner as for battery A. The CF (001) plane spacing of the obtained carbon fluoride is 7.0 Å. The peak ratio of CF (001)/C (002) by the X-ray diffraction is 30.

Next, carbon fluoride is prepared in the same manner as for battery A except that the fluorination temperature of petroleum coke is set to 420° C. and the reaction time is set to 20 hours. By using this carbon fluoride, battery F is produced in the same manner as for battery A. The CF (001) plane spacing of the obtained carbon fluoride is 6.8 Å. The peak ratio of CF (001)/C (002) by the X-ray diffraction is 50.

Next, carbon fluoride is prepared in the same manner as for battery A except that the fluorination temperature of petroleum coke is set to 400° C. and the reaction time is set to 90 hours. By using this carbon fluoride, battery G is produced in the same manner as for battery A. The CF (001) plane spacing of the obtained carbon fluoride is 7.7 Å. The peak ratio of CF (001)/C (002) by the X-ray diffraction is 30.

Next, carbon fluoride is prepared in the same manner as for battery A except that the fluorination temperature of petroleum coke is set to 430° C. and the reaction time is set to 70 hours. By using this carbon fluoride, battery H is produced in the same manner as for battery A. The CF (001) plane spacing of the obtained carbon fluoride is 7.5 Å. The peak ratio of CF (001)/C (002) by the X-ray diffraction is 60.

Next, carbon fluoride is prepared in the same manner as for battery A except that the fluorination temperature of petroleum coke is set to 390° C. and the reaction time is set to 30 hours. By using this carbon fluoride, battery I is produced in the same manner as for battery A. The CF (001) plane spacing of the obtained carbon fluoride is 7.0 Å. The peak ratio of CF (001)/C (002) by the X-ray diffraction is 20.

Next, carbon fluoride is prepared in the same manner as for battery A except that the fluorination temperature of petroleum coke is set to 430° C. and the reaction time is set to 10 hours. By using this carbon fluoride, battery J is produced in the same manner as for battery A. The CF (001) plane spacing of the obtained carbon fluoride is 6.5 Å. The peak ratio of CF (001)/C (002) by the X-ray diffraction is 50.

Next, carbon fluoride is prepared in the same manner as for battery A except that the fluorination temperature of petroleum coke is set to 390° C. and the reaction time is set to 110 hours. By using this carbon fluoride, battery K is produced in the same manner as for battery A. The CF (001) plane spacing of the obtained carbon fluoride is 7.8 Å. The peak ratio of CF (001)/C (002) by the X-ray diffraction is 30.

Batteries A to K produced as mentioned above are discharged at −10° C. at 100 mA for one second, and the minimum voltage during discharge is measured. Furthermore, batteries A to K are stored in a constant-temperature chamber at 85° C. for one month, and the internal resistances after storage are measured. Test results are shown in Table 1. The internal resistances are measured by allowing a sinusoidal A.C. current of 1 kHz and 0.1 mA to flow.

TABLE 1

| | Carbon | | | |
|---|---|---|---|---|
| | fluoride | Peak | −10° C. | Internal |
| | CF (001) | ratio of | discharge | resistance |
| | plane | CF(001)/ | voltage | after storage |
| | spacing (Å) | C(002) | (V) | (Ω) |
| Battery A | 7.2 | 40 | 2.45 | 0.60 |
| Battery B | 7.5 | 50 | 2.40 | 0.65 |
| Battery C | 7.5 | 30 | 2.45 | 0.68 |
| Battery D | 7.0 | 50 | 2.35 | 0.60 |
| Battery E | 7.0 | 30 | 2.40 | 0.65 |
| Battery F | 6.8 | 50 | 2.05 | 0.60 |
| Battery G | 7.7 | 30 | 2.45 | 1.05 |
| Battery H | 7.5 | 60 | 2.10 | 0.60 |
| Battery I | 7.0 | 20 | 2.40 | 1.50 |
| Battery J | 6.5 | 50 | 1.80 | 0.60 |
| Battery K | 7.8 | 30 | 2.45 | 1.30 |

In batteries F and J, the low-temperature discharge characteristics are low. This is probably because an interlayer space of carbon fluoride is narrow, and lithium ions are not easily inserted into the interlayer space of carbon fluoride. Also in battery H, the low-temperature discharge characteristics are low. This is probably because the amount of carbon, which are not fluorinated, on the surface of carbon fluoride is small, and thus the conductivity of the positive electrode mixture is lowered.

In batteries G and K, the low-temperature discharge characteristics are good, but the internal resistance after storage is increased. This is probably because the interlayer space of carbon fluoride is too large, and an excessive amount of the electrolytic solution enters and thereby decomposition of the electrolytic solution easily occurs. In battery I, the low-temperature discharge characteristics are good, but the internal resistance after storage at 85° C. for one month is increased. This is probably because an amount of carbon, which are not fluorinated, on the surface of carbon fluoride is large, which may cause the decomposition of the electrolytic solution.

In contrast, batteries A to E are excellent in the low-temperature discharge performance, and the internal resistance after storage at 85° C. for one month is low. Thus, the CF lithium primary battery using carbon fluoride having the CF (001) plane spacing of 7.0 Å or more and 7.5 Å or less and the peak ratio of CF (001)/C (002) of 30 or more and 50 or less for the positive electrode active material is excellent in both the low-temperature discharge characteristics and the high-temperature storage characteristics.

### INDUSTRIAL APPLICABILITY

A lithium primary battery of the present invention has excellent low-temperature discharge characteristics and high-temperature storage characteristics. Therefore, it is useful for applications of automobiles, industrial apparatuses, and the like, which are used in a wide temperature range from a high-temperature range to a low-temperature range.

1. A lithium primary battery comprising:
a positive electrode containing carbon fluoride as a positive electrode active material;
a negative electrode containing metallic lithium as a negative electrode active material; and
a separator and a nonaqueous electrolytic solution both disposed between the positive electrode and the negative electrode,
wherein the carbon fluoride includes a non-fluorinated carbon component, a spacing of a (001) plane of the carbon fluoride ranges from 7.0 Å to 7.5 Å, inclusive, and a ratio of an X-ray diffraction peak intensity of the (001) plane of the carbon fluoride to an X-ray diffraction peak intensity of a (002) plane of the non-fluorinated carbon component ranges from 30 to 50, inclusive.
